(19) United States
(12) Patent Application Publication
(10) Pub. No.: US 2008/0215925 A1
(43) Pub. Date: Sep. 4, 2008

(54) DISTRIBUTED FAULT INJECTION MECHANISM

(75) Inventors: LOUIS R. DEGENARO, White Plains, NY (US); James R. Challenger, Garrison, NY (US); James R. Giles, Yorktown Heights, NY (US); Gabriela Jacques Da Silva, Champaign, IL (US)

Correspondence Address: GEORGE A. WILLINGHAN, III;AUGUST LAW GROUP, LLC, P.O. BOX 19080, BALTIMORE, MD, 21284-9080, US

(73) Assignee: INTERNATIONAL BUSINESS MACHINES CORPORATION, ARMONK, NY (US)

(21) Appl. No.: 11/681,306

(22) Filed: Mar. 2, 2007

(51) Int. Cl. G06F 11/00

(52) U.S. Cl. 714/41; 714/E11.02

(57) ABSTRACT

Methods and systems are provided for testing distributed computer applications using finite state machines. A finite state machine definition for use in a distributed computer system is combined with the fault injections definitions contained within a fault injection campaign that is created for testing the computer application employing that finite state machine. The definition and combination of the finite state machine definition and the fault injection campaign is carried out automatically or manually, for example using a graphical user interface. This combination creates at least one modified finite state machine definition containing the desired injected faults. The modified finite state machine definition is separate from the originally identified finite state machine definition, and the originally identified finite state machine remains intact without injected faults. Trigger points within the finite state machine definition are identified for each fault injection test definition, and the modified finite state machine definition containing the fault injection test definition associated with a given trigger point are used in place of the original finite state machine definition upon detection of that trigger point during runtime of the finite state machine definition.

### STATEMENT REGARDING FEDERALLY SPONSORED RESEARCH

The invention disclosed herein was made with U.S. Government support under Contract No. H98230-05-3-0001 awarded by the U.S. Department of Defense. The Government has certain rights in this invention.

### FIELD OF THE INVENTION

The present invention relates to validation and testing of dependable systems.

### BACKGROUND OF THE INVENTION

In autonomic computing systems, self-healing and self-management are key characteristics. To reach high availability requirements, these autonomic computing systems have to minimize recovery time and assure that they can react and diagnose faults correctly. The ability of autonomic computing systems to survive under various abnormal behaviors of all the participating components distributed across a network of nodes remains a challenge. Tools have been developed to conduct tests that emulate these abnormal behaviors to verify that a given autonomic computing system will function as expected in response to the abnormal behaviors. These tools are referred to as fault injectors.

There are several fault injectors that help with the validation of distributed applications. Some of these fault injectors focus only on injecting faults in the message communication system. Examples of this type of fault injector include ORCHESTRA, which is described in S. Dawson, F. Jahanian, T. Mitton. ORCHESTRA: A probing and fault injection environment for testing protocol implementations, Proceedings of IPDS'96, Urbana-Champaign, Ill. (1996) and FIONA (Fault Injector Oriented to Network Applications), which is described in G. Jacques-Silva, et al. A Network-level Distributed Fault Injector for Experimental Validation of Dependable Distributed Systems, Proceedings of COMPSAC 2006, Chicago, Ill. (2006). ORCHESTRA inserts a protocol layer that filters messages between components in a distributed system. FIONA is a distributed tool that alters the flow of UDP (User Datagram Protocol) messages in Java programs. Both tools lack a broader fault model and the ability to define precise triggers based on application state.

Other tools that allow fault injection in remote nodes include NFTAPE (Network Fault Tolerance and Performance Evaluator), which is described in D. T. Stott, et al. NFTAPE: A framework for assessing dependability in distributed systems with lightweight fault injectors, Proceedings of the IEEE IPDS 2000, pages 91-100, Chicago, Ill. (2000) and Loki, which is described in R. Chandra, et al. A global-state-triggered fault injector for distributed system evaluation, IEEE Transactions on Parallel and Distributed Systems, 15(7):593-605, July (2004). NFTAPE presents a generic way to inject faults, allowing the user to create light-weight fault injectors in order to conduct an experiment through the definition of a fault injection campaign script. The campaign script runs in a control host that drives the experiment in one remote node through a process manager. Its design facilitates the injection of faults externally to the application, for example, through the operating system, but it does not inject faults based on the application state.

Loki allows fault injection in multiple nodes based on a partial view of the application global state. The drawback of this approach is that the application has to be explicitly instrumented with state notifications and fault injection code. Also, a state machine should be defined to describe both the distributed system and the global state in which the fault will be injected. Such tasks get more complicated when the system runs in a heterogeneous environment, where there is no guarantee concerning the language in which the applications are implemented and the state in which each of these pieces will be disposed in at each time interval. Multithreaded applications where each thread has its own state may also cause problems when defining a state for a single process.

### SUMMARY OF THE INVENTION

Systems and methods in accordance with the present invention provide for validating the robustness of a distributed computing system driven by a finite state machine (FSM) by augmenting the state machine definition to permit a test engineer to inject errors based on the system state and to facilitate injection of errors in other nodes of the distributed computing system. The distributed computing system can then be precisely tested under an array of fault conditions. Providing fault injection in a plurality of different system states guarantees that the system is tested in different scenarios, increasing the number of test cases and the test coverage of the fault tolerance mechanisms.

In accordance with exemplary embodiments of the present invention, a FSM description is automatically modified in a controlled manner to define fault injection tests without modifying the control flows originally defined by the FSM. Precise fault injection triggers are defined based on the application state, allowing the test engineer to increase the test coverage.

A fault injection campaign is defined in a standardized format, e.g., an extensible markup language (XML) document, by specifying the current state and the transition in which the fault injection will take place. This fault injection campaign is defined by the user or test engineer. The faulty behavior is chosen from a fault injection library or defined by the tester. After the fault injection campaign is defined, the FSM description is used to produce one or more faulty FSM's that include fault injection annotations, and the FSM Engine calls the fault injection methods when appropriate. The fault injection code does not modify the existing working code of the FSM, which avoids inserting errors due to code instrumentation. Using methods for testing in accordance with the present invention, the user or test engineer easily adds faults, removes faults and modifies faulty behavior without modifying the original code. The tester can automatically generate tests by modifying a configuration file. In distributed systems, the locations where the faults are to be injected are also distributed. For example, a given test may involve the forced termination of a remote process to verify that a central server properly handles the termination. Systems and methods in accordance with the present invention utilize standard communication and remote execution mechanisms to activate the injection of faults in a distributed manner. This invention can also exploit the methods disclosed in U.S. patent application no. 11/620,558, filed Jan. 5, 2007 and titled “Distributable and Serializable Finite State Machine”, to inject faults across a collection of nodes. Therefore, systems and methods in accordance with the present invention provide the ability to inject faults based on application state without extra code instrumentation.

To inject faults while executing a method, the use of annotations to specify the position in the code where a fault should be injected can be used as an alternative to the usual breakpoint setting approach. Therefore, a relative address is utilized instead of an absolute address, which does not require any test reconfiguration in case of modification of the target application source code.

In accordance with one exemplary embodiment, the present invention is directed to a method for testing distributed computer applications using finite state machines. Initially, at least one finite state machine definition for use in a distributed computer system is identified. A fault injection campaign for testing the computer application employing the finite state machine is defined. The fault injection campaign includes at least one fault injection test definition. In order to facilitate the creation of the fault injection campaign, a graphical user interface that displays a graphical representation of the distributed computer application, the finite state machine, the available fault injection test definitions or combinations thereof can be used to define manually the fault injection campaign. Alternatively, an automatic fault injection test generator in communication with a fault injection description library is used to automatically create one or more fault injection test definitions.

Having identified the finite state machine and defined the fault injection test campaign, the identified finite state machine definition is combined with each fault injection test definition in the test campaign to create at least one modified finite state machine definition containing injected faults. Each modified finite state machine definition so generated is separate from the original identified finite state machine definition, and the original identified finite state machine remains without injected faults. These injected faults include, but are not limited to, a faulty method within an existing transition, a faulty transition that moves the finite state machine to a new state and combinations thereof. The injected faults cause at least one of an actual fault, entry into debug mode, sending a message, logging a message and combinations thereof.

In one embodiment, combining the finite state machine definition with each fault injection test definition includes combining the finite state machine definition with each fault injection test definition to create a single modified finite state machine definition containing a plurality of injected faults. Each injected fault corresponds to one of the fault injection test definitions. In another embodiment, a plurality of finite state machine definitions is identified for use concurrently in the distributed computer system. Therefore, combining the finite state machine definitions includes combining each one of the plurality of finite state machine definitions with each fault injection test definition to create at least one composite modified finite state machine definition containing the injected faults. In one embodiment, the finite state machine definition and each fault injection test definition are combined dynamically during runtime of the finite state machine definition on the distributed computing system.

In order to provide for the initiation of fault testing, a trigger point within the finite state machine definition is identified for each fault injection test definition In one embodiment, at least one composite trigger point having components from two or more finite state machine definitions is identified. In another embodiment a state, a transition, a method within a transition or a combination thereof is identified with the finite state machine as a trigger point. In one embodiment, the finite state machine is modified to insert user-defined trigger points. For example, a java debugging interface is used to modify the finite state machine. These user-defined trigger points include, but are not limited to, data watch points, instruction breakpoints and combinations thereof. In one embodiment, the source code for the finite state machine is annotated using a fault inject language to identify the trigger points. In one embodiment, a graphical user interface is used to identify the trigger points. Suitable trigger points include a single point on a single node and a collection of trigger points that are distributed among at least two nodes within the distributed computing system.

Upon detection of a specified trigger point during runtime, the modified finite state machine definitions that contain the fault injection test definitions associated with the detected trigger point are used.

In one embodiment, the present invention is directed to a method for assuring fault tolerance of a distributed computer application through automatic generation of fault injection campaigns within the distributed computer application. The fault injection campaigns are automatically generated by inputting a distributed computer application definition in a standardized format and at least one fault injection description library in standardized format into an automatic fault injection generator. Therefore, the fault generator contains the definition of the computer application and access to a plurality of potential injected faults. The automatic fault injection generator uses these inputs to produce at least one fault injection test definition. This fault injection test definition and the distributed computer application definition in standardized format are then inputted into a transformation engine. The transformation engine uses these inputs to produce a modified distributed computer application instrumented with the desired faults. The instrumented, modified distributed computer application is used to observe, to measure or to test the fault tolerance of the distributed computer application.

### BRIEF DESCRIPTION OF THE DRAWINGS

FIG. 1 is the overall fault injection process, where the user defines a fault injection test which is merged with the original FSM definition to generate a modified FSM definition with the faulty behavior;

FIG. 2 shows how fault injection tests can be automatically generated based on the description of the faulty behaviors implemented and the FSM definition;

FIG. 3 shows how a transition definition would be changed to form a test FSM after being processed by the FSM transformation engine;

FIG. 4 shows the emulation of a faulty behavior by creating a faulty transition;

FIG. 5 shows the emulation of a faulty behavior by creating a faulty state;

FIG. 6 shows interfaces for fault injection configuration;

FIG. 7 shows dynamic fault injection configuration;

FIG. 8 shows annotation method for specifying fault injection triggers;

FIG. 9 shows fault injection based on state of more than one FSM;

FIG. 10 shows fault injection based on state of more than one FSM distributed among more than one processing node; and

FIG. 11 shows application state-based fault injection technique employing code breakpoint triggering.

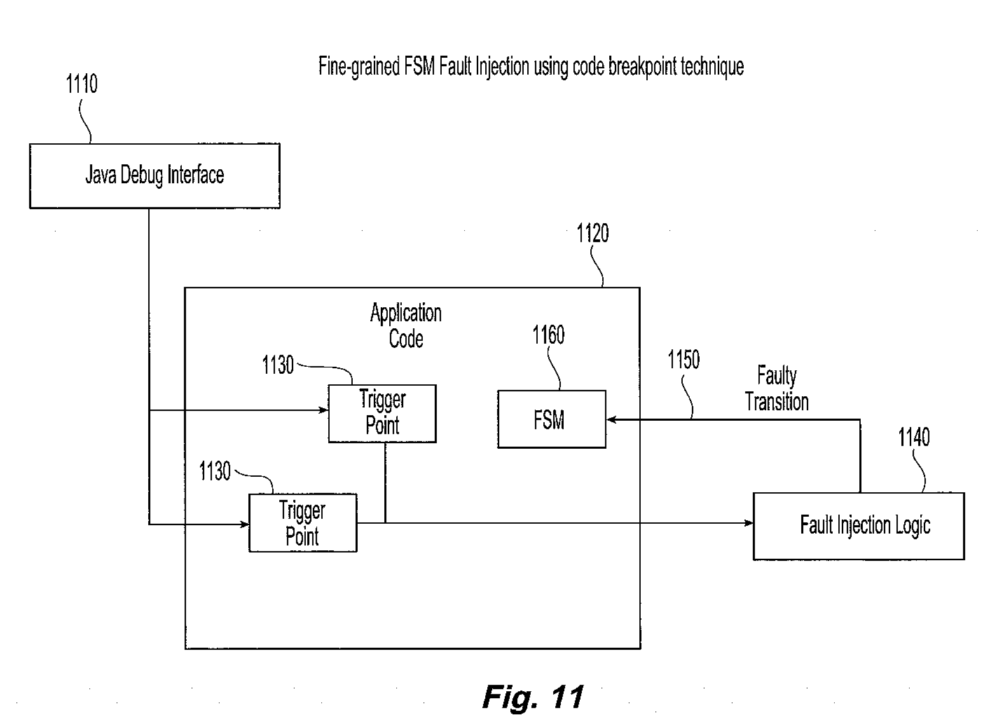

### DETAILED DESCRIPTION

Systems and methods in accordance with the present invention provide for the verification and validation of detection and recovery mechanisms within fault tolerant autonomic computing systems. Reliability in the detection and recovery mechanisms is provided by testing the detection and recovery mechanism under a variety of fault scenarios. In one embodiment, the distributed application or distributed computing system is described using a finite state machine (FSM). Suitable methods for using FSM's to describe and to materialize a distributed application are disclosed in U.S. patent application Ser. No. 11/444,129, filed May 31, 2006 and titled “Data Driven Finite State Machine For Flow Control”. Exemplary systems for fault emulation in accordance with the present invention also include a fault injection library or plug-in, which implements the behavior of the faults to be injected, and a fault injection campaign language to describe the test experiment. A FSM transformation engine is provided to convert the FSM description of a given distributed application into a faulty FSM. In addition, the fault testing mechanism includes a campaign generator to read the possible fault injection methods and to automatically generate test descriptions. In one embodiment, a graphical user interface (GUI) is provided to allow the user to graphically specify which states and nodes to test and which fault model to use. The GUI can be used for both offline test campaign generation and for realtime or runtime injection of faults. In one embodiment, different faulty scenarios are created automatically based on the current state of the application.

A fault injection campaign is separately described from the target application to be tested. The fault injection campaign language, for specifying the test campaign, includes a description of which faults are to be injected. It may contain both information that implies a modification directly to the FSM and also information related to the configuration of the fault injection library, e.g., timer trigger. It can be described in a standardized format according to a fault injection schema, such as the following extensible markup language (XML) schema:

```
<?xml version=“1.0” encoding=“UTF-8”?>
<xsd:schema xmlns:xsd=“http://www.w3.org/2001/XMLSchema”
xmlns:fsm_fi=“http://www.ibm.com/distillery/fsm_fi” elementFormDefault=“qualified”
targetNamespace=“http://www.ibm.com/distillery/fsm_fi”>
<xsd:element name=“faultInjection”>
  <xsd:complexType name=“target”>
        <xsd:sequence>
      <xsd:element maxOccurs=“1” name=“node” type=“xsd:string” use=“optional”/>
      <xsd:element maxOccurs=“1” name=“trigger” type=“triggerType”/>
      <xsd:element maxOccurs=“1” name=“state” type=“xsd:string” use=“required”/>
      <xsd:element maxOccurs=“1” name=“transition” type=“xsd:string”
use=“required”/>
      <xsd:element maxOccurs=“1” name=“beforeMethod” type=“xsd:string”
use=“optional”/>
      <xsd:element maxOccurs=“1” name=“afterMethod” type=“xsd:string”
use=“optional”/>
      <xsd:element maxOccurs=“1” name=“injectionClass” type=“xsd:string”
use=“required”/>
      <xsd:element maxOccurs=“1” name=“injectionMethod” type=“xsd:string”
use=“required”/>
      </xsd:sequence>
        <xsd:attribute name=“id” type=“xsd:string” use=“required”/>
        <xsd:attribute name=“peId” type=“xsd:string” use=“optional”/>
        <xsd:attribute name=“executableName” type=“xsd:string” use=“required”/>
  </xsd:complexType>
</xsd:element>
<xsd:complexType name=“triggerType”>
        <xsd:attribute name=“timer” type=“timerType” use=“required”/>
        <xsd:attribute name=“jobNumber” type=“xsd:string” use=“optional”/>
        <xsd:attribute name=“peNumber” type=“xsd:string” use=“optional”/>
</xsd:complexType>
<xsd:complexType name=“timerType”>
        <xsd:attribute name=“minTime” type=“decimal” use=“optional” default=“0”/>
        <xsd:attribute name=“maxTime” type=“decimal” use=“optional”
default=“10000”/> <!-- 10 seconds -->
<xsd:complexType>
<xsd:schema>
```

The implementation of fault injection methods, which emulate the faulty behavior desired by the tester, may be through the use of pre-implemented methods from a fault injection library or plug-in. These fault-providing methods may accept runtime configuration options described in the fault injection test XML document.

An integration process occurs, whereby the faults described by a Fault Injection specification XML are merged with the faultless FSM XML document to formulate a new combined XML document that describes the original application now instrumented with faults. The merge process can be performed automatically. The merge process can occur statically, before application launch—this is necessary for those cases where faults are injected as part of the application bring up process. The merge process can also occur dynamically during runtime—thus, faults can be injected and removed “on the fly”. The locations where faults are injected during runtime are trigger points.

In one embodiment, the system utilizes a FSM transformation engine for fault injection. The faultless FSM is described by an XML document. The states and transitions of the faultless FSM are defined in the XML document. Each transition contains one or more methods that are executed when the transition is initiated. These methods are also defined in the XML document. In one embodiment, a description of each fault injection experiment contains information regarding the state, the transition and the methods within the transition between which the error is going to be injected. In order to generate the modified FSM automatically, the FSM transformation engine is used to identify the appropriate state and transition elements that should be altered. When the FSM state and transition values match to the ones in the test description, a new method element is created, with values corresponding to the fault injection library reference and a method which implements the behavior wanted by the tester. Faulty behavior may include an actual fault, entry into debug mode, sending or logging of a message and combinations thereof.

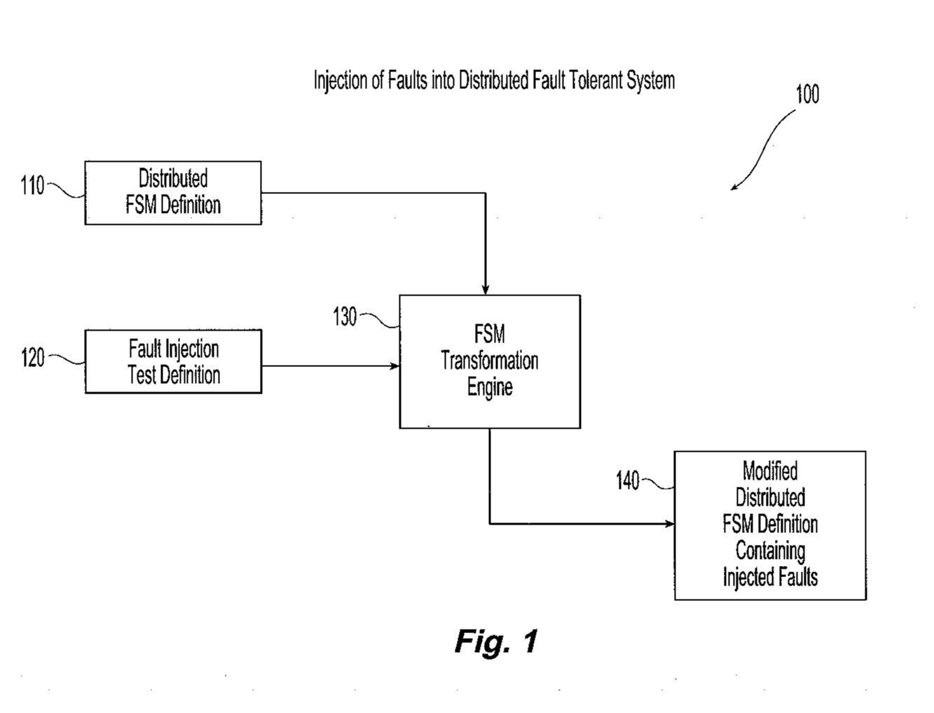

Referring to FIG. 1, an exemplary embodiment of the use of an FSM transformation engine 100 is illustrated. The FSM transformation engine 130 receives separate XML documents as input and produces a combined modified XML document. In one embodiment, one set of XML documents are FSM definitions, and another set of XML documents are test definitions. As illustrated, the FSM transformation engine receives a faultless distributed FSM definition 110 and a single fault injection test definition 120. The FSM transformation engine examines and processes these inputs and produces a modified FSM 140 that is a combination of the faultless FSM definition and the fault injection test definition. Therefore, the output is a modified FSM definition that contains the desired fault for testing.

As used herein, a fault injection campaign refers to a collection or grouping of faults targeted for a common entity, for example a single faultless FSM or distributed computer application. Therefore, a given fault injection campaign includes a plurality of fault injection test definitions where each fault injection test definition is created to test a particular aspect of a computing system that is governed by a FSM. This prescribed plurality of fault injection test definitions is introduced or injected into the otherwise faultless FSM. Each one of the plurality of fault injection test definitions contained within a given fault injection campaign can be manually created or user-defined or can be generated automatically, for example by identifying the desired faults from a pre-defined repository of fault injection descriptions such as a fault injection description library and creating the appropriate fault injection test definitions for the FSM definition to be tested. In one embodiment, all the faults within the test definition are exhaustively employed. In another embodiment, a subset of faults to employ is selected randomly. In one embodiment, faults are selected according to a prioritization scheme.

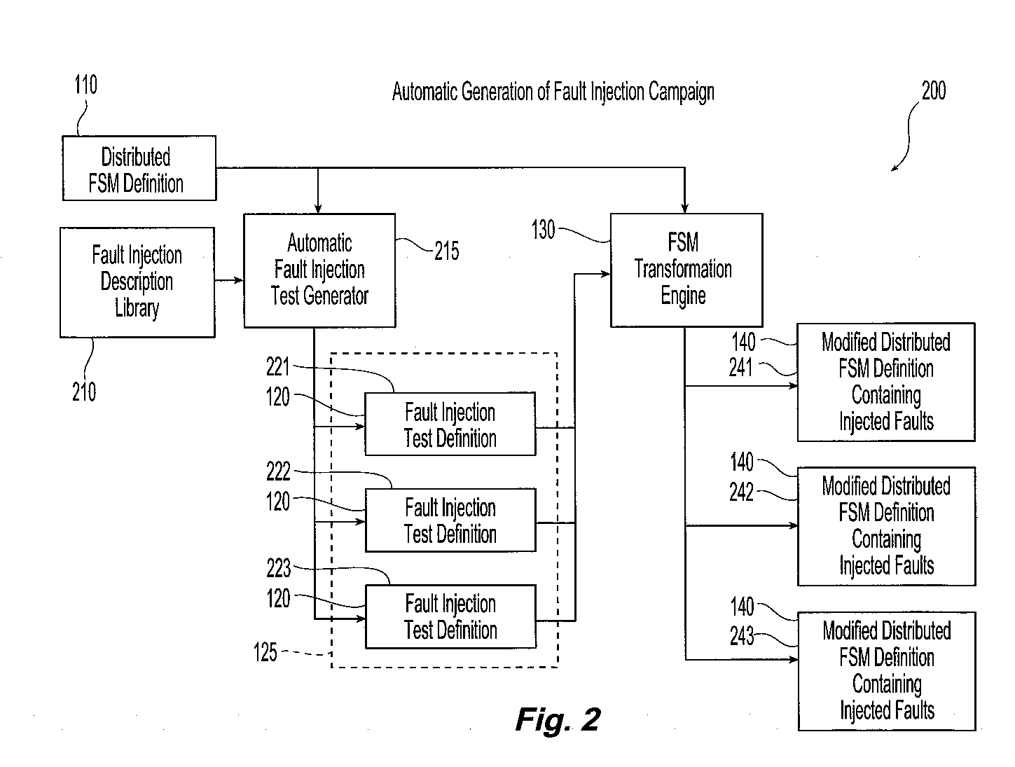

Referring to FIG. 2, an exemplary embodiment of the use of a fault library 200 to automatically generate a fault injection campaign in accordance with the present invention is illustrated. The fault injection description library 210 contains a plurality of pre-defined fault injection descriptions that embody a plurality of prescribed faults. These fault injection descriptions are used to automatically generate the fault injection campaign. An automatic fault injection test generator 215 is in communication with the fault injection description library. Suitable fault injection test generators include any type of computing system or processor capable of identifying suitable fault injection descriptions form the library, of extracting or reading the suitable fault injection descriptions from the library, of creating the appropriate fault injection test definitions for the FSM definition that embody the fault injection descriptions and of communicating or writing the fault injection definitions to a desired destination. In addition to being in communication with the fault injection description library, the distributed FSM definition 110 to be tested is communicated to the automatic fault injection test generator 215.

In one embodiment, the automatic fault injection test generator 215 that is in communication with a fault injection description library generates the fault injection campaign 125 by creating a plurality of fault injection test definitions 120 that embody the desired fault injection descriptions for the FSM definition to be tested. Each fault injection test definition is selected based upon its ability to test a desired fault in a computing system that is controlled by a known FSM. This plurality of fault injection test definitions 120 is communicated to the FSM transformation engine 130. In addition, the FSM transformation engine 130 again receives as input a FSM definition 110 for a given computing system. Therefore, instead of receiving a single fault injection test definition, the FSM transformation engine receives a plurality of fault injection test definitions 120. The FSM transformation engine uses the plurality of fault injection test definitions in combination with the FSM definition to produce one or more modified FSM definitions 140 that each contains one or more of the injected faults from the fault injection campaign.

As illustrated, the fault injection test generator created three fault injection test definitions 221, 222, 223. All three fault injection test definitions 221, 222, 223 are communicated to the FSM transformation engine 130. The FSM transformation engine uses these fault injection test definitions in combination with the faultless FSM description 110 to produce a set of FSM definitions containing faults 140. In one embodiment, the fault injection test definitions 221, 222, and 223 are used to produce three modified distributed FSM definitions containing injected faults 241, 242, and 243 respectively. Therefore, one modified FSM definition is created for each fault injection test definition in the fault injection campaign. Alternatively, two or more of the fault injections test definitions are combined into a single modified FSM definition. Thus, the FSM Transformation Engine 130 injects multiple fault injection test definitions into the FSM definition to form a combined single FSM containing multiple faults. For example, the plurality of FSM definitions containing faults 140 could be merged into a single modified FSM containing a plurality of faults.

The modification of the faultless FSM definition to include the desired faults includes identifying trigger points within the FSM definition. These trigger points are locations within the FSM definition where faults are injected. A given trigger point is an identification of a state and transition within the FSM definition where a fault is to be injected. When, during the execution of the computing system in accordance with the FSM definition, the state and transition values match a given trigger point, a new method element is instituted that is capable of implementing the desired faulty behavior. This can be instituted by placing a call to an appropriate fault injection method. Therefore, the original FSM definition does not have to be modified or changed, but instead a separate routine is run.

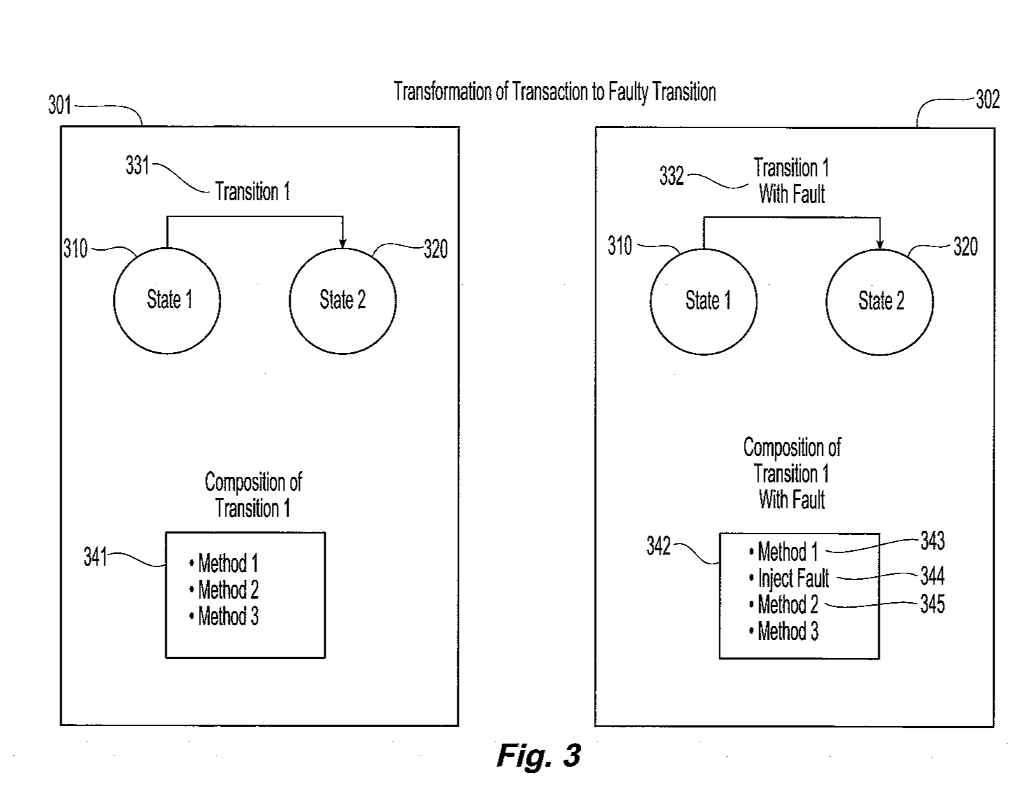

Referring to FIG. 3, an exemplary embodiment of a modified transition to inject a prescribed fault is illustrated. As illustrated, the trigger point identifies State 1 and Transition 1 as the location for injecting the fault. Transition 1 moves the FSM from State 1 to State 2 by executing a plurality of methods. This transition between the states is illustrated in both an original or faultless form 301 and a modified form 302 containing a fault. Both the faultless and faulted transitions move the FSM from State 1 310 to State 2 320. The faultless transition “Transition 1” 331 moves the FSM from “State 1”, 310 to “State 2” 320 without any injected fault. In order to transition the FSM from the first state to the second state, a series or sequence of methods is executed. This series of methods is the composition of Transition 1 341. Each method is a named code segment. Upon creation of a modified transition that injects a fault into the FSM, a modified “Transition 1 With Fault” 332 is created. The modified Transition 1 332 also transitions the FSM between State 1 310 and State 2 320. The sequence of methods that is executed in accordance with the modified Transition 1 332 is changed to the composition of Transition 1 with faults 342. As illustrated, an “Inject Fault” 344 method was inserted in the sequence subsequent to “Method 1” 343 and prior to “Method 2” 345. The “Inject Fault” 344 method corresponds to and triggers the execution of an additional named code segment during runtime that executes the desired fault. In one embodiment, the composition of Transition 1 with faults is produced by an FSM Transformation Engine 130 of FIGS. 1 and 2.

In this embodiment, injection of the fault into the FSM definition does not modify existing application code within the FSM. That is, the existing methods within the transition were not modified. Therefore, the introduction of bugs due to the addition of instrumentation code is avoided. Instead, a new FSM definition is created that can be employed during test cycles. In addition, the external definition of a test campaign without application recompilation allows one to easily add these tests to the application build process, adding them as unit tests for the fault detection and failure recovery code.

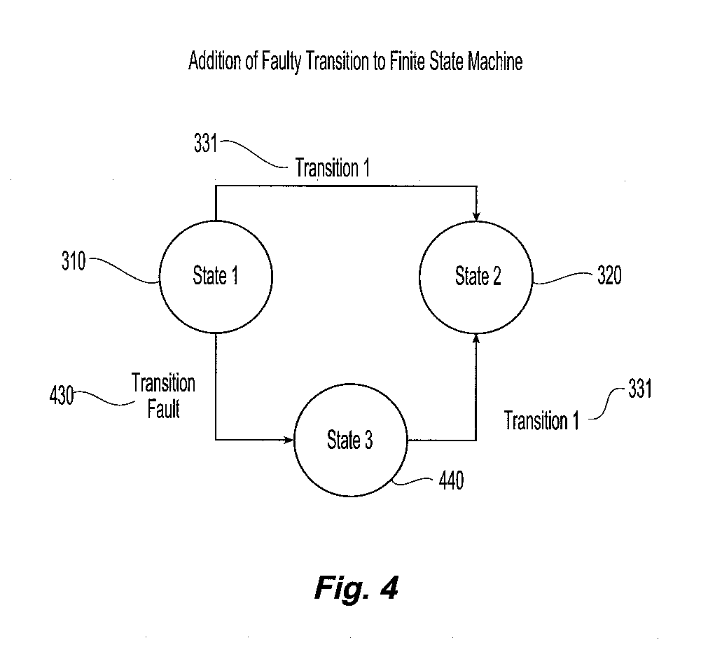

Referring to FIG. 4, another exemplary embodiment of a modified FSM definition that has been generated by the automatic fault injection test generator to contain a prescribed fault is illustrated. Instead of creating a modified transition by injecting a fault within the methods of that transition, an additional fault transition and an additional fault state are added. The original faultless FSM contains “Transition 1” 330 that moves the FSM from “State 1” 310 to “State 2” 320. Again, the trigger point is State 1 and Transition 1; however, the modified FSM that contains new state “State 3” 440 and “Transition Fault” 430 that moves the modified FSM from “Transition 1” 431 to “State 3”. In one embodiment, State 3 is a fault state. When the modified FSM is being used and is in “State 1” 311 and the “Transition Fault” is presented to the FSM, the next state becomes “State 3”. Therefore, the faulty transition “Transition Fault” 430 places the distributed computing system into the fault state. Processing of the FSM continues, subsequent to the injected fault, by following “Transition 1” 331, which moves the FSM to “State 2” 320 as would have occurred in the corresponding faultless FSM.

A signal to the faulty FSM to perform a faulty transition, e.g. one that contains a fault injection method, does not necessarily result in an immediate fault injection. In one embodiment, the occurrence of a trigger point initiates a process of injecting the prescribed fault into the FSM. The actual injection of the fault, however, can be timing based and subject to a delay. This delay can be the result of a predetermined delay or the result of having to wait for the completion of another task within the computing system before the prescribed fault can be injected. In addition, trigger points may be remotely located from the injected fault or faults in a distributed application. Therefore, the trigger points can be located on a first node within the computing system, and the trigger point institutes the injection of a prescribed fault on another, remote node of the computing system.

With an FSM based trigger, we have complete control of the state in which an error is being injected. However, without code change, it can not inject errors inside a specific method. That is, the granularity of control for injection of faults is between methods, as shown in FIG. 3 with the insertion of the Inject Fault 344 method between Method 1 343 and Method 2 345. Injection of a fault somewhere within Method 1 343 instead of between Method 1 and Method 2 is a more challenging problem. The desired error can be injected if the method, Method 1, is divided into two methods, for example Method 1-A and Method 1-B, and both methods are used together to replace Method 1 in the FSM description. The error injection method would then be added between the two methods. Thus, to use the FSM-based fault injection technique of the present invention as described above, the application is modified with an FSM transition between the divided methods. An alternative approach is described below.

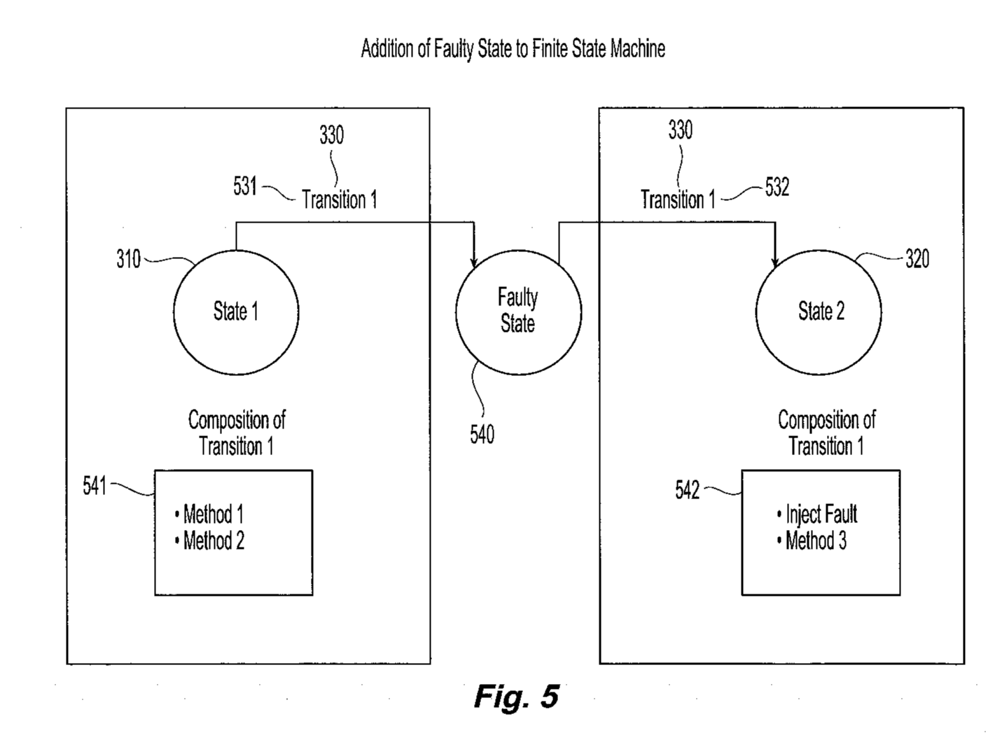

Referring to FIG. 5, another exemplary embodiment of a modified FSM definition that has been generated by the automatic fault injection test generator to contain a faulty state is illustrated. The original faultless FSM contains “Transition 1” 330 that moves the FSM from “State 1” 310 to “State 2” 320. The modified FSM has been created to contain a new “Faulty State” 540 and transitions to “Transition 1” 531 and from “Transition 1” 532 the new state. Therefore, the same transition, i.e. Transition 1 is used to advance the FSM to the faulty state and from the faulty state depending upon the state of the FSM when that transition is initiated. Employing this faulty FSM, when in “State 1” 310 and when a first occurrence of “Transition 1” 531 is presented to the FSM, the methods associated with the composition of the first occurrence of Transition 1 541 are executed to advance the FSM to the next state, which is the “Faulty State” 540. The actions taken by entering, being in, or exiting “Faulty State” 540, cause a fault to be injected into the represented distributed system at the desired time and place. Processing then continues, subsequent to the injected fault, by following a second occurrence of “Transition 1” 532 that causes the methods associated with the composition of the second occurrence of Transition 1 542 to be executed to advance the FSM to the next state, which is “State 2” 321 as would occur in the corresponding faultless FSM. Thus, in this example, when in State 1 and “Transition 1” occur, the now faulty FSM moves to Faulty State. From this Faulty State, when the next occurrence of “Transition 1” occurs, the now faulty FSM moves to State 2. This kind of fault injection can test, for example, a missing “Transition 1” that should have taken the faultless FSM from State 1 to State 2. With the injected fault, it now takes two occurrences of “Transition 1” to move from State 1 to State 2. In addition, other fault related event and state may be introduced by the faulty state and/or the transitions to and from it. As shown with respect to FIG. 4 above, a new transition could instead be used, depending on the desired test circumstances.

As was illustrated above with respect to FIG. 2, the campaign generator or automatic fault injection generator 215 uses the original FSM and the fault injection library description, e.g., fault injection methods called by trigger points, as inputs and automatically generates multiple fault injection test definitions 120. The multiple test experiments are automatically generated by combining different faulty behaviors in different trigger points (states, transitions, methods) of the FSM. The user can configure the faulty behaviors to be generated as desired. In addition, the user can indicate whether or not to randomize runtime fault injection parameters. Thus, the campaign generator can be used to inject faulty transitions (e.g. FIG. 3 and FIG. 4) and faulty states (e.g. FIG. 5).

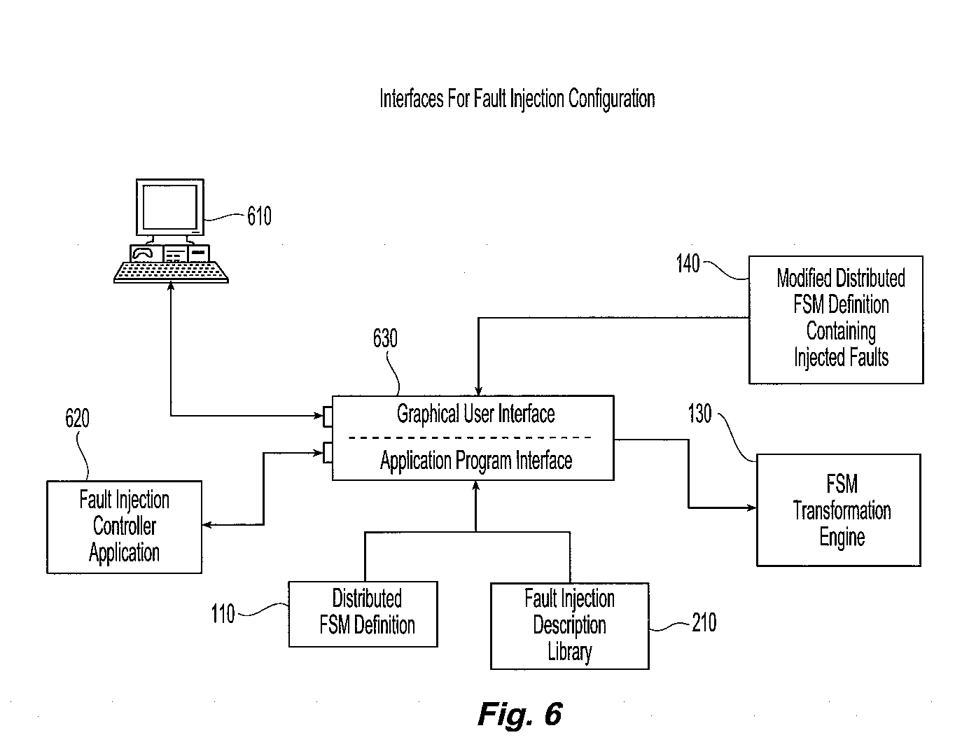

Referring to FIG. 6, an exemplary embodiment of the use of a graphical user interface (GUI) to constrain and otherwise control the fault injection campaign is illustrated. The GUI 630 is used to build fault injection campaigns graphically, where the user has the FSM represented in a diagram and can drag and drop faults in the diagram. The GUI 630 retrieves a faultless FSM 110 and available faults from the fault injection description library 210 and provides graphical representations of both the faultless FSM and the available faults to the user. The interface 630 is used in conjunction with a display device 610 for interacting with a user. Suitable display devices include computers. In one embodiment, the GUI interface represents faults, FSM transitions, FSM states, FSM methods and trigger points as icons that can be selected or manipulated within the graphical environment. The user selects a target location within the FSM for injection of a prescribed fault, for example a state, a transition or a method within a transition, and drags an icon representing the desired fault onto an icon representing the desired location to create a fault experiment request. This process is repeated for as many locations and faults as desired. After all of the desired faults have been selected and matched to the desired locations, the user uses the GUI to initiate the generation of the modified FSM. In one embodiment, the user selects an icon within the GUI environment that represents the FSM transformation engine 130. This causes the FSM transformation engine 130 to generate the modified FSM containing faults 140. The modified FSM is then deployed to the test environment for execution of the fault testing campaign. In one embodiment, the modified FSM can be displayed and manipulated within the GUI environment so that the user can further modify the FSM or can use the FSM as a template for the generation of additional modified FSMs. A programmatic interface 620 can also be provided to permit application programs to perform the above described fault injection activities either in addition to or as an alternative to the GUI.

In one embodiment, the GUI is used to generate the fault campaign offline before the computing system or application is initialized. Therefore, states and transitions that occur during initialization are tested. Alternatively, the GUI is used to generate the test campaign online during runtime of the computing system or application. Once generated, the faulty application as provided in the modified FSM is deployed to a test environment were the test engineer can proceed with testing the behavior of the application for correctness in the presence of the introduced fault or faults.

In one embodiment, a given computing system or application contains more than one FSM. Methods in accordance with the present invention are used to combine the state of various FSMs to define a more complex trigger point containing a collection of distributed trigger points in the target application. This trigger point collection may span two or more nodes comprising a distributed application. The collection of FSMs form a composite FSM, and the corresponding collection of FSM trigger points form a composite trigger point.

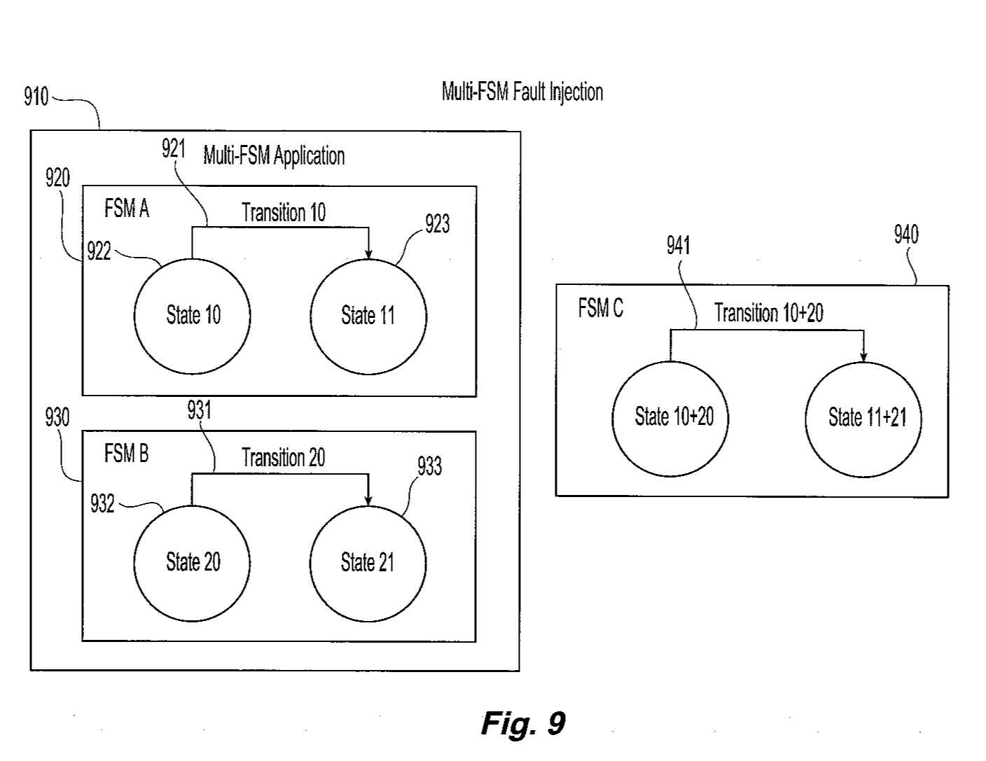

Referring to FIG. 9, an exemplary embodiment of a multi-FSM fault injection arrangement is illustrated. As illustrated, an application 910 contains two FSMs. Although illustrated with two FSMs, other applications can contain more than two FSMs. FSM A 920 and FSM B 930 control two separate tasks within the application. For example, FSM A controls the steps for performing one task, and FSM B controls the steps for another task. These tasks are performed in parallel. Using the present invention as described with respect to FIG. 3, each of these FSMs can be modified so that transitions within these FSMs cause fault injections. For example, in FSM A, “Transition 10” 921 moves the FSM from State 10 922 to State 11 923, and in FSM B, “Transition 20” 931 moves that FSM from State 20 932 to State 21 933. Either “Transition 10” 921 or “Transition 20” 922 is modified to cause the fault injection. In addition, both of these transitions can be modified to cause fault injections. Faults can occur in these two FSMs separately and independently of each other. Alternatively, a new composite FSM C 940, which is a composite of FSM A and FSM B, is created. In the composite FSM, fault injection does not occur independently in the FSMs that are contained in the composite FSM. Instead, fault injection only occurs when both FSMs are each in a prescribed state, and each FSM follow prescribed transition out of their prescribed state. Therefore, the trigger point is a composite trigger point that contains two states, one in each FSM and two transitions, one in each FSM. In the example, the fault is injected not when either “Transition 10” or “Transition 20” occurs, but when both have occurred. Therefore, FSM A is in State 10 and FSM B is in state 20 and both “Transition 10” and “Transition 20” occur, which is represented as “Transition 10+20” 941.

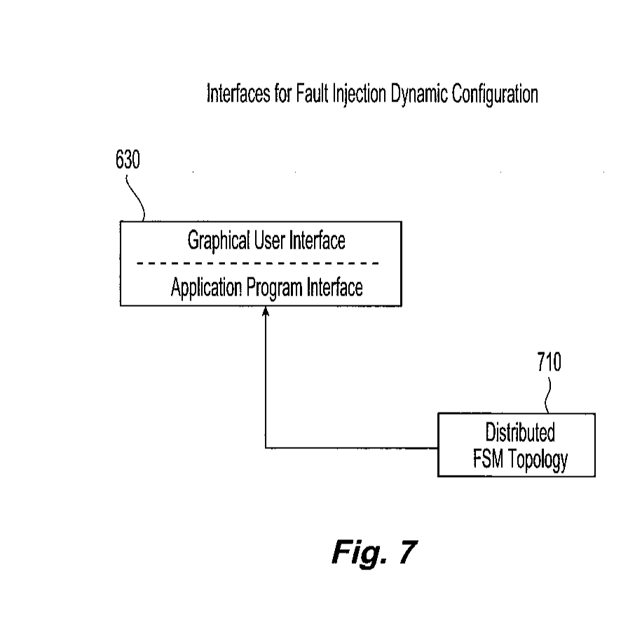

Referring to FIG. 7, an exemplary embodiment of how a GUI 630 is supplied with the runtime topology of a distributed FSM 710 in accordance with the present invention is illustrated. The topology of the distributed FSM represents the network of distributed states and is communicated to the GUI. This topology can then be displayed in the GUI to facilitate identification of places within the topology that a user wants to inject a fault in addition to facilitating the placement of a fault within the FSM at the identified place. Using a display, keyboard or any other suitable input/output device in communication with the GUI 630, the user selects the desired node, the FSM in the node and the target state or transition for injecting a fault.

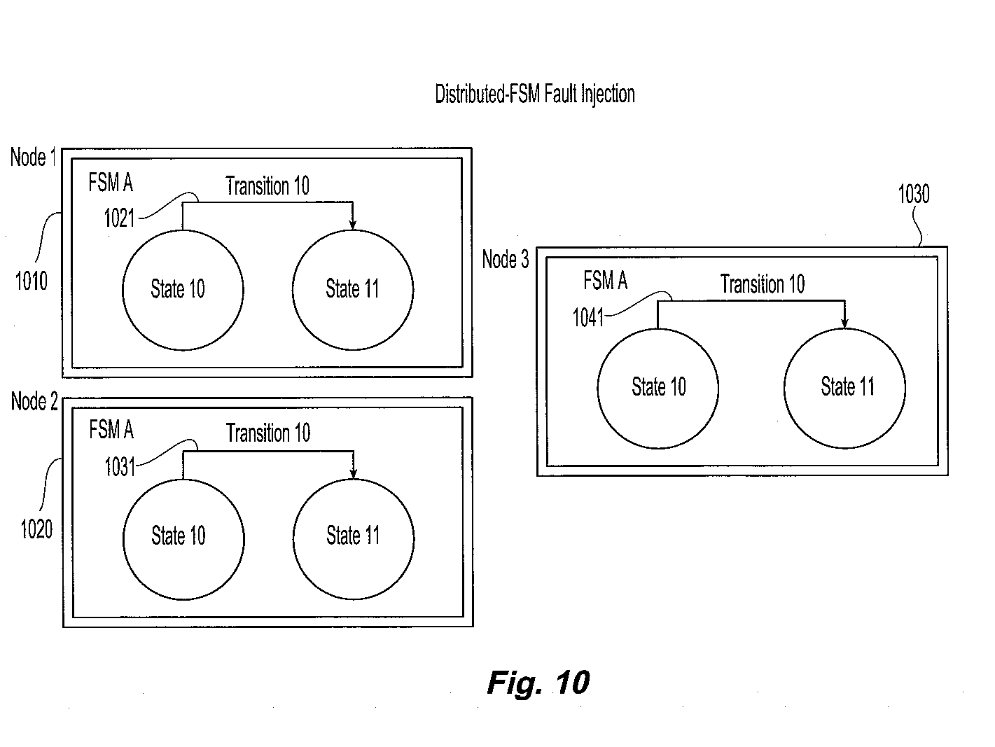

Referring to FIG. 10, an exemplary embodiment of distributed topology that is communicated to and displayed within the GUI is illustrated. As illustrated, different instances of the same FSM A are deployed to and executed on different nodes within a given computing system. Therefore, FSM A is running on each of Node 1 1010, Node 2 1020 and Node 3 1030. As disclosed with reference to FIG. 7, this distributed topology is exploited for fault injection. A GUI is used to inject a fault when the instance of FSM A on Node 1 performs “Transition 10” 1021. As disclosed with reference to FIG. 9, this distributed topology can also be exploited for multi-FSM fault injection. The GUI is used to inject a fault when all three instances of FSM A concurrently perform “Transition 10” 1021, 1031, 1041.

As discussed above, trigger points are used to initiate the injection of prescribed faults within the FSM. At least three different trigger point types can be used. In general, these different trigger point mechanisms can be differentiated using the level of control afforded each mechanism, from coarse grained to fine grained control. The most coarse grained control mechanism uses existing transitions, states and methods within the FSM as trigger points. A finer grained control mechanism uses trigger points or flags (e.g., faulty methods such as Inject Fault 344 of FIG. 3) that are added to the FSM for example by adding flags to the sequences of methods within a transition's execution sequence. The finest grain control uses code annotations that expand into executable trigger points when compiled with fault injection enabled, i.e., relative address, rather than address-based breakpoint techniques as trigger points for the initiation of fault introduction into the FSM.

The addressed-based triggering technique can be used in conjunction with application state-based fault injection techniques described above. Fault injection is triggered by intercepting the processing of the FSM using an external agent, for example a debugging interface as shown with reference to FIG. 1. For Java programs, one of the available interfaces is the Java Debugging Interface (JDI) 1110, which can be used to access the running state of a virtual machine application 1120. The debugging interface provides functions to intercept the program, such as setting data watch points or instruction breakpoints. Using this kind of interface, the tester can specify fine-grained triggers for fault injection by setting breakpoint locations 1130 in the code, which may be distributed across two or more nodes upon which the distributed application is running. For example, when a number of hits in certain locations of the program are reached as determined by test probe fault injection logic 1140 an error is enqueued to be injected. This would be done by enqueing an event to take a faulty transition 1150. The error is not injected right after the injection condition is reached, but when the faulty transition is taken by the FSM 1160.

In lieu of using specific debugger aids, such as JDI, a more universal approach to provide trigger points for fault injection is to annotate code using a fault inject language. For normal compilations, those without faults, the annotations describing faults are simply ignored and the application executes following normal, unaltered code paths. When the test engineer wants to perform testing with faults, the identical code is re-compiled with fault injection enabled, and the resulting application executes utilizing the fault injection test code.

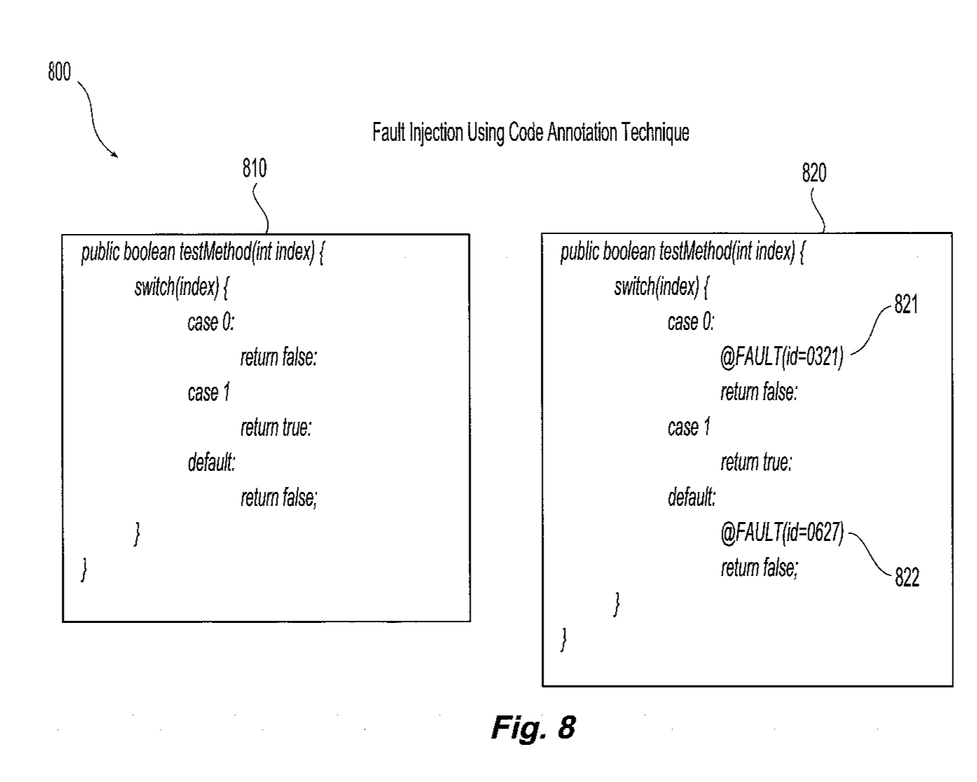

Referring to FIG. 8, an exemplary embodiment of Java code fragments 800 modified for fault injection is illustrated. A first Java code fragment 810 is the original Java code before fault injection annotation. A second Java code fragment 820 illustrates the original code following fault injection annotation. As illustrated, two trigger points 821, 822 are specified. In one embodiment, trigger points are added by editing the source code and typing in the correct annotation language specification. Alternatively, a drag and drop GUI is used to drag faults into the code, similar to the process described with respect to FIG. 6 above.

When compiled with fault injection disabled, both code fragments result in the identical executable code when compiled with fault injection enabled the non-annotated code fragment 810 results in the original executable code. However, the modified annotated code fragment 820 contains additional code that corresponds to injecting the specified fault from a fault injection library. In this example, two faults are shown 821, 822. Each fault has an identity, 0321 and 0627 respectively, which identifies the fault to be injected. A mapping function is employed to map between the trigger points 821, 822 during runtime and the deployed fault injection library. When the trigger point is executed during code traversal during runtime, the fault injection library is consulted to find and to inject the specified fault.

Methods and systems in accordance with exemplary embodiments of the present invention can take the form of an entirely hardware embodiment, an entirely software embodiment or an embodiment containing both hardware and software elements. In a preferred embodiment, the invention is implemented in software, which includes but is not limited to firmware, resident software and microcode. In addition, exemplary methods and systems can take the form of a computer program product accessible from a computer-usable or computer-readable medium providing program code for use by or in connection with a computer, logical processing unit or any instruction execution system. For the purposes of this description, a computer-usable or computer-readable medium can be any apparatus that can contain, store, communicate, propagate, or transport the program for use by or in connection with the instruction execution system, apparatus, or device. Suitable computer-usable or computer readable mediums include, but are not limited to, electronic, magnetic, optical, electromagnetic, infrared, or semiconductor systems (or apparatuses or devices) or propagation mediums. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

Suitable data processing systems for storing and/or executing program code include, but are not limited to, at least one processor coupled directly or indirectly to memory elements through a system bus. The memory elements include local memory employed during actual execution of the program code, bulk storage, and cache memories, which provide temporary storage of at least some program code in order to reduce the number of times code must be retrieved from bulk storage during execution. Input/output or I/O devices, including but not limited to keyboards, displays and pointing devices, can be coupled to the system either directly or through intervening I/O controllers. Exemplary embodiments of the methods and systems in accordance with the present invention also include network adapters coupled to the system to enable the data processing system to become coupled to other data processing systems or remote printers or storage devices through intervening private or public networks. Suitable currently available types of network adapters include, but are not limited to, modems, cable modems, DSL modems, Ethernet cards and combinations thereof.

In one embodiment, the present invention is directed to a machine-readable or computer-readable medium containing a machine-executable or computer-executable code that when read by a machine or computer causes the machine or computer to perform a method for testing a distributed computer application in accordance with exemplary embodiments of the present invention and to the computer-executable code itself. The machine-readable or computer-readable code can be any type of code or language capable of being read and executed by the machine or computer and can be expressed in any suitable language or syntax known and available in the art including machine languages, assembler languages, higher level languages, object oriented languages and scripting languages. The computer-executable code can be stored on any suitable storage medium or database, including databases disposed within, in communication with and accessible by computer networks utilized by systems in accordance with the present invention and can be executed on any suitable hardware platform as are known and available in the art including the control systems used to control the presentations of the present invention.

While it is apparent that the illustrative embodiments of the invention disclosed herein fulfill the objectives of the present invention, it is appreciated that numerous modifications and other embodiments may be devised by those skilled in the art. Additionally, feature(s) and/or element(s) from any embodiment may be used singly or in combination with other embodiment(s) and steps or elements from methods in accordance with the present invention can be executed or performed in any suitable order. Therefore, it will be understood that the appended claims are intended to cover all such modifications and embodiments, which would come within the spirit and scope of the present invention.

What is claimed is:

1. A method for testing a distributed computer application comprising:
identifying a finite state machine definition for use in a distributed computer system;
defining a fault injection campaign comprising at least one fault injection test definition;
combining the finite state machine definition with each fault injection test definition to create at least one modified finite state machine definition comprising injected faults, each modified finite state machine definition separate from the identified finite state machine definition and the identified finite state machine remaining without injected faults;
identifying a trigger point within the finite state machine definition for each fault injection test definition; and
initiating use of the modified finite state machine definition comprising the fault injection test definition associated with a given trigger point upon detection of that trigger point during runtime of the finite state machine definition.

2. The method of claim 1, wherein the step of defining the fault injection campaign further comprises using a graphical user interface to manually define the fault injection campaign.

3. The method of claim 1, wherein the step of defining the fault injection campaign further comprises using an automatic fault injection test generator in communication with a fault injection description library to automatically create one or more fault injection test definitions.

4. The method of claim 1, wherein the injected faults comprise a faulty method within an existing transition, a faulty transition that moves the finite state machine to a new state or combinations thereof.

5. The method of claim 1, wherein the step of combining the finite state machine definition with each fault injection test definition further comprises combining the finite state machine definition with each fault injection test definition to create a single modified finite state machine definition comprising a plurality of injected faults, each injected fault corresponding to one of the fault injection test definitions.

6. The method of claim 1, wherein the step of identifying a finite state machine definition further comprises identifying a plurality of finite state machine definitions for use concurrently in the distributed computer system and the step of combining the finite state machine definition further comprises combining each one of the plurality of finite state machine definitions with each fault injection test definition to create at least one composite modified finite state machine definition comprising injected faults.

7. The method of claim 6, wherein the step of identifying a trigger point further comprises identifying at least one composite trigger point having components from two or more finite state machine definitions.

8. The method of claim 1, wherein the step of identifying a trigger point further comprises identifying within the finite state machine a state, a transition, a method within a transition or a combination thereof.

9. The method of claim 1, wherein the step of identifying a trigger point further comprises modifying the finite state machine to insert user-defined trigger points.

10. The method of claim 9, wherein the step of modifying the finite state machine further comprises using a java debugging interface to modify the finite state machine.

11. The method of claim 9, wherein the user-defined trigger points comprise data watch points, instruction breakpoints or combinations thereof.

12. The method of claim 1, wherein the step of identifying trigger points further comprises annotating source code for the finite state machine using a fault inject language.

13. The method of claim 1, wherein the step of identifying trigger points further comprises using a graphical user interface to identify the trigger points.

14. The method of claim 1, wherein the trigger point comprises a collection of trigger points that are distributed among at least two nodes within the distributed computing system.

15. The method of claim 1, wherein the injected faults cause at least one of an actual fault, entry into debug mode, sending a message, logging a message and combinations thereof.

16. The method of claim 1, wherein the step of combining the finite state machine definition further comprises combining the finite state machine definition and each fault injection test definition dynamically during runtime of the finite state machine definition on the distributed computing system.

17. A method for assuring fault tolerance of a distributed computer application through automatic generation of fault injection campaigns, the method comprising:
inputting a distributed computer application definition in a standardized format and at least one fault injection description library in standardized format into an automatic fault injection generator;
producing from the automatic fault injection generator at least one fault injection test definition;
inputting the distributed computer application definition in the standardized format and the at least one fault injection test definition into a transformation engine; and
producing from the transformation engine a modified distributed computer application definition instrumented with one or more faults capable of assuring fault tolerance within the distributed computer application definition.

18. The method of claim 17, further comprising using the modified distributed computer application definition to test the fault tolerance of the distributed computer application definition.

19. A computer-readable medium containing a computer-readable code that when read by a computer causes the computer to perform a method for testing a distributed computer application, the method comprising:
identifying a finite state machine definition for use in a distributed computer system;
defining a fault injection campaign comprising at least one fault injection test definition;
combining the finite state machine definition with each fault injection test definition to create at least one modified finite state machine definition comprising injected faults, each modified finite state machine definition separate from the identified finite state machine definition and the identified finite state machine remaining without injected faults;
identifying a trigger point within the finite state machine definition for each fault injection test definition; and
initiating use of the modified finite state machine definition comprising the fault injection test definition associated with a given trigger point upon detection of that trigger point during runtime of the finite state machine definition.

20. The computer readable medium of claim 19, wherein the step of defining the fault injection campaign further comprises using a graphical user interface to manually define the fault injection campaign.
